(19) United States
(12) Patent Application Publication
(10) Pub. No.: US 2024/0353287 A1
(43) Pub. Date: Oct. 24, 2024

(54) INSPECTION DEVICE AND INSPECTION METHOD

(71) Applicant: Mitsubishi Electric Corporation, Tokyo (JP)

(72) Inventors: Norihiko HANA, Tokyo (JP); Masao AKIYOSHI, Tokyo (JP); Masaki UMEDA, Tokyo (JP); Kenji AMAYA, Tokyo (JP); Takuya IWAMOTO, Tokyo (JP)

(73) Assignee: Mitsubishi Electric Corporation, Tokyo (JP)

(21) Appl. No.: 18/684,852

(22) PCT Filed: Aug. 25, 2021
(86) PCT No.: PCT/JP2021/031082

§ 371 Date: Feb. 20, 2024

(51) Int. Cl. G01M 7/02; G01H 9/00

(52) U.S. Cl. CPC G01M 7/025; G01H 9/00

(57) ABSTRACT

An inspection device includes: a data recording unit which records, in advance, change of a natural frequency caused when a rigidity of a supported part of an inspection target object and a damage size of the inspection target object are changed; a measurement unit which measures vibration response of the vibration-applied inspection target object; and an estimation unit which estimates the rigidity of the supported part of the inspection target object and the damage size of the inspection target object, simultaneously, on the basis of change of the natural frequency between a natural frequency of the inspection target object calculated from the vibration response and a natural frequency obtained by measuring the inspection target object whose damage state has already been known, and the change of the natural frequency recorded in the data recording unit.

### TECHNICAL FIELD

The present disclosure relates to an inspection device and an inspection method.

### BACKGROUND ART

Damage inside a structure cannot be inspected by visual check, and the damage expands without being noticed by normal inspection, thus influencing the life of the structure. Therefore, detecting damage inside a structure is an important problem for structure inspection.

In general, as methods for inspecting damage inside a structure in a non-destructive manner, change of vibration response of a structure, ultrasonic testing, and X-ray inspection are known. In a case of using change of vibration response of a structure, the device size can be easily reduced as compared to other non-destructive inspection methods, and contactless measurement can be performed. However, the method of using change of vibration response is not a method of measuring reflection from inside damage using ultrasonic waves, X-rays, or the like, and therefore needs to estimate inside damage through inverse analysis using the relationship between change of vibration response of a structure and inside damage.

For example, it is known that sound is applied to an inspection target object to excite deflection vibration, the excited deflection vibration is detected, and the natural frequency of the inspection target object is estimated on the basis of the frequency and the amplitude of the detected deflection vibration, thereby inspecting the state of the inspection target object (see Patent Document 1).

### CITATION LIST

### Patent Document

Patent Document 1: Japanese Laid-Open Patent Publication No. 2004-69301

### SUMMARY OF THE INVENTION

### Problem to be Solved by the Invention

A crack is estimated from change of vibration response of an inspection target object. However, vibration response changes also when a condition for supporting the inspection target object is changed. Therefore, change due to the support condition and change due to a crack cannot be separated from each other, so that there is a problem that crack estimation accuracy is reduced.

The present disclosure has been made to solve the above problem, and an object of the present disclosure is to provide an inspection device and an inspection method with which accuracy for estimating the size of damage that cannot be seen from a surface is improved even if the rigidity of a supported part is changed.

### Means to Solve the Problem

An inspection device according to the present disclosure includes: a data recording unit which records, in advance, change of a natural frequency caused when a rigidity of a part where an inspection target object is supported and a size of damage of the inspection target object are changed; a measurement unit which measures vibration response of the inspection target object subjected to vibration application; and an estimation unit which estimates the rigidity of the part where the inspection target object is supported and the size of damage of the inspection target object, simultaneously, on the basis of change of the natural frequency between a natural frequency of the inspection target object calculated from the vibration response measured by the measurement unit and a natural frequency obtained by measuring the inspection target object whose damage state has already been known, and the change of the natural frequency recorded in the data recording unit.

### Effect of the Invention

The crack inspection device according to the present disclosure can estimate the rigidity of the part where the inspection target object is supported and the size of damage that cannot be seen from a surface, simultaneously, and thus accuracy for estimating the size of damage that cannot be seen from a surface can be estimated even if the rigidity of the supported part is changed.

### BRIEF DESCRIPTION OF THE DRAWINGS

FIG. 1 is a block diagram of an inspection device according to embodiment 1.

FIG. 2 is a schematic diagram showing an inspection target and the inspection device according to embodiment 1.

FIG. 3 shows rigidities of support portions of the inspection target shown in FIG. 2.

FIG. 4 illustrates an example of a hardware configuration of a control device according to embodiment 1.

FIG. 5 shows examples of vibration modes in a case where there is a crack in the inspection target.

FIG. 6 shows an example in which the natural frequency changes due to change of rigidities of parts supporting the inspection target.

FIG. 7 shows an example in which the natural frequency changes in a case where there is a crack in the inspection target.

FIG. 8 shows an example in which the natural frequency changes due to a crack and change of rigidities of support portions of the inspection target.

FIG. 9 is a flowchart illustrating an estimation method in the inspection device according to embodiment 1.

FIG. 10 is a calculation flow of a natural frequency probability distribution A calculating unit, in the flow of the estimation method.

FIG. 11 illustrates a calculation flow of a measured natural frequency probability distribution B calculating unit, in the flow of the estimation method.

FIG. 12 illustrates a calculation flow for calculating a crack size and a support condition that maximize a product of a probability distribution A and a probability distribution B.

FIG. 13 illustrates vibration modes in which the natural frequency changes due to damage that cannot be seen from a surface, in an inspection target.

FIG. 14 is a block diagram of an inspection device according to embodiment 2.

FIG. 15 illustrates change of a vibration-application frequency during operation or between operation and stop of an inspection target according to embodiment 3.

FIG. 16 illustrates an example of a hardware configuration of a control device according to embodiment 3.

FIG. 17 is a schematic diagram showing an inspection target and an inspection device according to embodiment 4.

FIG. 18 is a flowchart illustrating an estimation method in the inspection device according to embodiment 4.

FIG. 19 is another flowchart illustrating an estimation method in the inspection device according to embodiment 4.

FIG. 20 illustrates an example of a hardware configuration of a control device according to embodiment 4.

FIG. 21 is a schematic diagram showing an inspection target and an inspection device according to embodiment 5.

FIG. 22 is a schematic diagram showing an inspection target and an inspection device according to embodiment 6.

FIG. 23 is a schematic diagram showing an inspection target and an inspection device according to embodiment 7.

### DESCRIPTION OF EMBODIMENTS

Hereinafter, a crack inspection device according to embodiments for carrying out the present disclosure will be described in detail with reference to the drawings. In the drawings, the same reference characters denote the same or corresponding parts.

### Embodiment 1

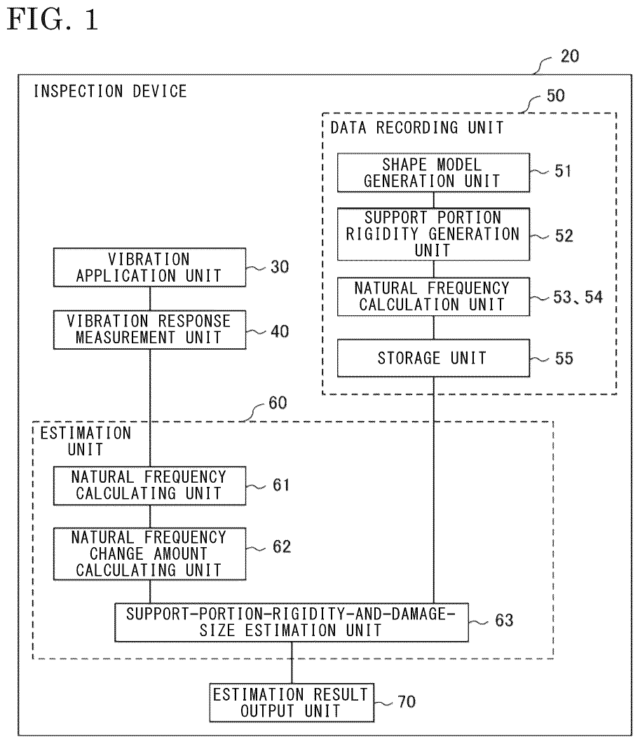

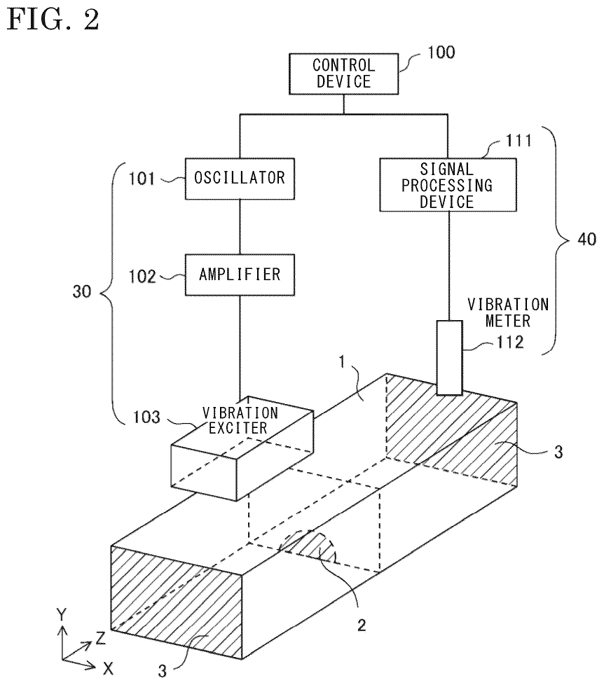

FIG. 1 is a block diagram showing a configuration example of an inspection device according to embodiment 1, and FIG. 2 is a schematic diagram showing an inspection target and the crack inspection device according to embodiment 1.

### Outline Explanation of Inspection Device

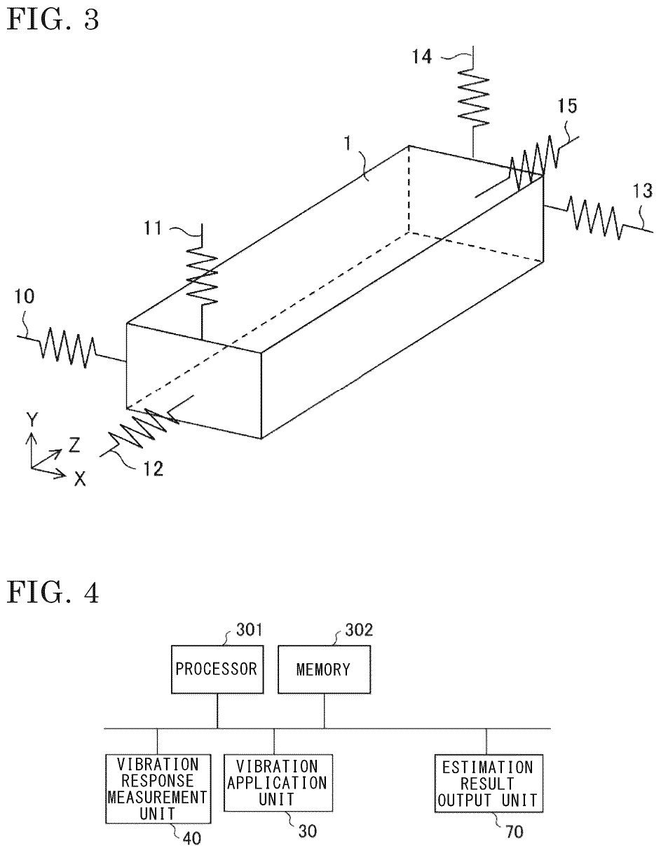

A crack inspection device 20 (hereinafter, referred to as inspection device 20) shown in FIG. 1 includes a vibration application unit 30 for applying vibration to an inspection target 1, a vibration response measurement unit 40 for measuring vibration response of the vibration-applied inspection target 1, a data recording unit 50 which records vibration response of the inspection target 1 when rigidities of support portions 3 of the inspection target 1 shown in FIG. 2 are changed, an estimation unit 60 which estimates, from the measured vibration response, rigidities of parts (hereinafter, support portions) 3 supporting the inspection target 1 and the size of a crack 2 which is damage that cannot be seen from a surface, and an estimation result output unit 70 which outputs an estimation result of the estimation unit 60. FIG. 3 shows rigidities of the support portions 3 of the inspection target 1. In FIG. 3, the inspection target 1 is supported at both ends, on three axes X, Y, Z of a coordinate system shown in FIG. 3. Rigidities 11 to 15 of the support portions 3 are represented in spring forms. As the support structure, bolt fixation, press-fitting, or the like may be used instead of a spring.

In FIG. 1, the vibration application unit 30 includes an oscillator 101, an amplifier 102, and a vibration exciter 103 shown in FIG. 2, and is controlled by a control device 100. The vibration response measurement unit 40 includes a signal processing device 111 and a vibration meter 112 shown in FIG. 2, and is controlled by the control device 100, as with the vibration application unit 30.

For the inspection target 1, an oscillation signal is generated by the oscillator 101 on the basis of a signal inputted from the control device 100, and then is inputted to the amplifier 102. The oscillation signal amplified by the amplifier 102 is inputted to the vibration exciter 103, to apply vibration to the inspection target 1. The vibration exciter 103 is, for example, an electric actuator, a hydraulic actuator, or the like.

Vibration response of the vibration-applied inspection target 1 is measured by the vibration meter 112, the measured vibration response is converted to an electric signal by the signal processing device 111, and the electric signal is inputted to the control device 100, whereby measurement of vibration response through vibration application is controlled. The vibration meter 112 is, for example, an acceleration meter or the like.

In the present embodiment, functions of the inspection device 20 are included in the control device 100. That is, functions of the data recording unit 50, the estimation unit 60, and the estimation result output unit 70 described below are included in the control device. An internal configuration of the control device 100 will be described later.

In the data recording unit 50 in FIG. 1, change of the natural frequency of the inspection target 1 due to change of the rigidities 11 to 15 of the support portions 3 of the inspection target 1 shown in FIG. 2 or FIG. 3 is calculated and a result thereof is recorded.

The relationship between the rigidities 11 to 15 of the support portions 3 and the natural frequency of the inspection target 1 to be recorded in the data recording unit 50 may be obtained by actually measuring vibration while changing the rigidities of the support portions or may be obtained through numerical analysis. In the present embodiment, an example of using numerical analysis is shown in FIG. 1.

In the numerical analysis, first, a numerical model of the inspection target 1 is generated by a shape model generation unit 51 in the data recording unit 50. Next, a numerical model of parts supporting the shape model is generated by a support portion rigidity generation unit 52. By natural frequency calculation units 53, 54 for natural frequencies generated while changing the support condition for the numerical-modeled inspection target, natural frequencies are calculated while the support condition for the inspection target 1 is changed in the numerical model. The calculation result is stored as data in a storage unit 55.

In the estimation unit 60 in FIG. 1, from the vibration response measured by the vibration response measurement unit 40, a natural frequency is calculated by a natural frequency calculating unit 61. From the calculated natural frequency, a change amount of the natural frequency is calculated. From data of the natural frequency stored in the data recording unit 50 and the change amount of the natural frequency calculated from the measured vibration response, the rigidities 11 to 15 of the support portions 3 and the size of the crack 2 of the inspection target 1 are estimated by a support-portion-rigidity-and-damage-size estimation unit 63. The estimation result of the estimation unit 60 is outputted by the estimation result output unit 70.

FIG. 4 is a schematic diagram showing an example of hardware in the control device 100.

The data recording unit 50 and recording of vibration response data of the vibration response measurement unit 40, which are functions of the inspection device in the control device 100, are implemented by a memory 302. The memory 302 is, for example, a nonvolatile or volatile semiconductor memory such as a read only memory (ROM), a random access memory (RAM), a flash memory, an erasable programmable read only memory (EPROM), or an electrically erasable programmable read only memory (EEPROM), or a magnetic disk, a flexible disk, an optical disc, a compact disc, a mini disc, a digital versatile disc (DVD), etc.

Operation in the data recording unit 50 and operation in the estimation unit 60 are implemented by a processor 301 such as a CPU or a system LSI which executes a program recorded in the memory 302. A plurality of processing circuits may cooperate to execute the above functions. The above functions may be implemented by dedicated hardware. In a case of implementing the above functions by dedicated hardware, the dedicated hardware is, for example, a single circuit, a complex circuit, a programmed processor, an application specific integrated circuit (ASIC), a field programmable gate array (FPGA), or a combination thereof. The above functions may be implemented by a combination of dedicated hardware and software or a combination of dedicated hardware and firmware. For example, operation in the data recording unit 50 and operation in the estimation unit 60 may be implemented by the processor 301 such as a CPU or a system LSI which executes a program recorded in the memory 302.

As with execution of the functions of the inspection device, control of the vibration application unit 30 and the vibration response measurement unit is implemented by the processor 301 executing a program recorded in the memory 302.

### Explanation of Change Amount of Natural Frequency

The natural frequency calculating unit 61 and a natural frequency change amount calculating unit 62 in the estimation unit 60 will be described in detail.

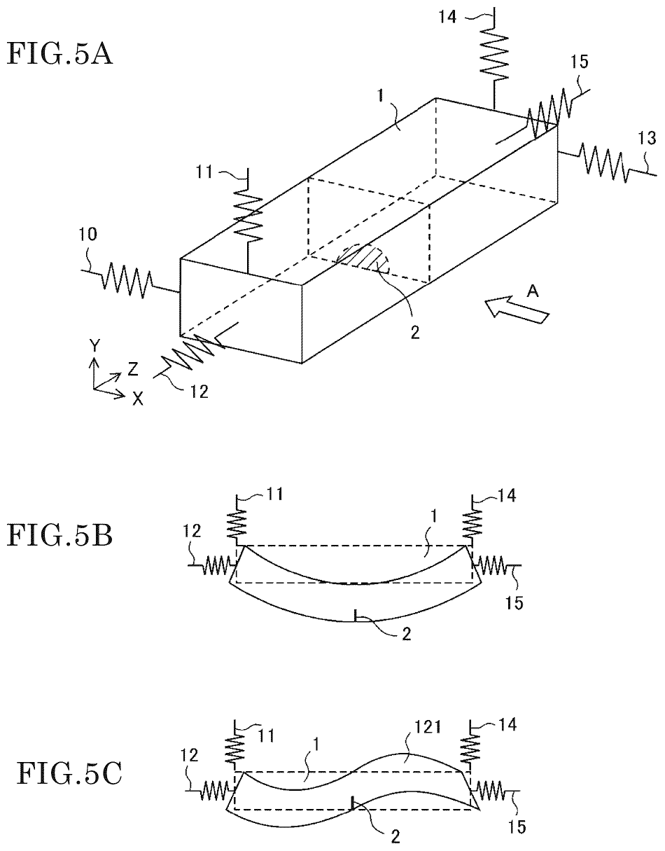

FIG. 5 illustrates vibration modes in a case where there is a crack in the inspection target 1. As shown in FIG. 5(a), in a case where there is the crack 2 in the inspection target 1, the natural frequency changes. FIG. 5(b) and FIG. 5(c) show examples of vibration modes in the case where there is the crack 2 in the inspection target 1. FIG. 5(b) and FIG. 5(c) are views of the inspection target 1 as seen in a direction A in FIG. 5(a). With reference to these drawings, change in the vibration mode due to the crack 2 will be described. As shown in FIG. 5(b), in the vibration mode in which the rigidity of the inspection target is partially changed due to the crack 2 and the rigidity-changed part is greatly deformed, change of the natural frequency due to the crack 2 is great. In contrast, as shown in FIG. 5(c), in the vibration mode in which the rigidity-changed part is not deformed, change of the natural frequency due to the crack 2 is small. In the present embodiment, description will be given using a mode in which change of the natural frequency due to the crack 2 is great (the mode as shown in FIG. 5(b)) among a plurality of vibration modes of the inspection target.

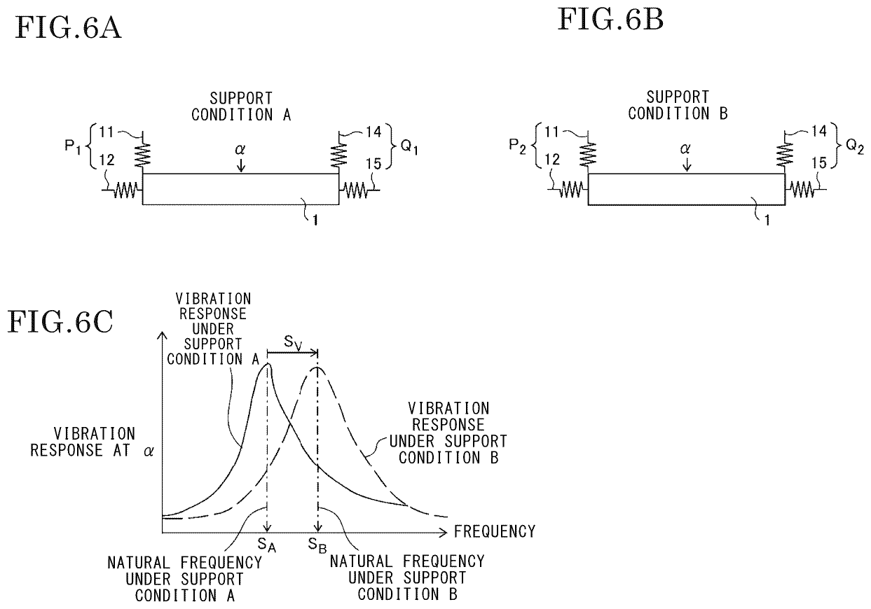

FIG. 6 shows an example in which the natural frequency changes due to change of the rigidities of the support portions of the inspection target 1. FIG. 6(a) shows a case of a support condition A in which the rigidities 11, 12 of the support portions correspond to springs P1 and the rigidities 14, 15 correspond to springs Q1. A point at which response is measured is a point α. In a support condition B in FIG. 6(b), the rigidities 11, 12 of the support portions correspond to springs P2 and rigidities 14, 15 correspond to springs Q2. A point at which response is measured is the same point α as in FIG. 6(a). The measured vibration responses are shown as a schematic graph in FIG. 6(c) in which the horizontal axis indicates a frequency and the vertical axis indicates response displacement. In FIG. 6(c), vibration response under the support condition A is indicated by a solid line, and vibration response under the support condition B is indicated by a broken line. Under each of the support conditions A, B, the natural frequency calculating unit 61 calculates the natural frequency from vibration response in the mode in which change of the natural frequency is great. In FIG. 6(c), S_{A} is the natural frequency under the support condition A, and S_{B} is the natural frequency under the support condition B. The natural frequency change amount calculating unit 62 calculates a change amount S_{V} from the natural frequency S_{A} to the natural frequency S_{B}.

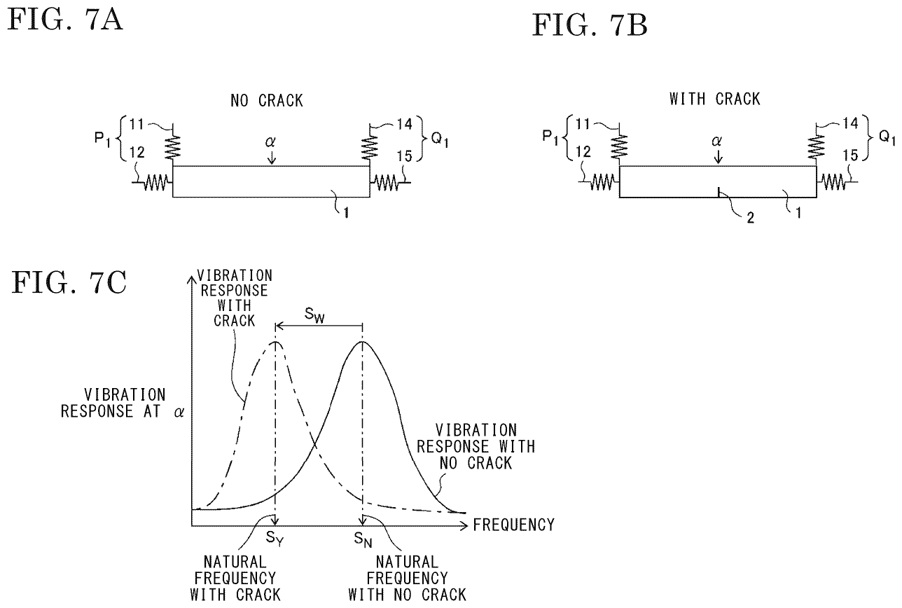

FIG. 7 shows an example in which the natural frequency changes due to the crack 2. The rigidities 11, 12 of the support portions correspond to the springs P1, and the rigidities 14, 15 correspond to the springs Q1, and this is the same as in the support condition A described in FIG. 6. A point at which response is measured is a point α as in FIG. 6. A case where there is the crack 2 is a case where there is the crack 2 in the inspection target 1 under the support condition A, as shown in FIG. 7(b). The measured vibration responses are shown as a schematic graph in FIG. 7(c) in which the horizontal axis indicates a frequency and the vertical axis indicates response displacement. In FIG. 7(c), vibration response with no crack 2 is indicated by a solid line, and vibration response with the crack 2 is indicated by a dotted-dashed line. The natural frequency calculating unit 61 calculates the natural frequency from vibration response in the mode in which change of the natural frequency due to presence/absence of the crack and due to the crack 2 is great. In FIG. 7(c), S_{N} is the natural frequency with no crack 2, and S_{Y} is the natural frequency with the crack 2. The natural frequency change amount calculating unit 62 calculates a change amount S_{W} from the natural frequency S_{N}to the natural frequency S_{Y}. The change amount S_{W} of the natural frequency changes depending on not only presence/absence of a crack but also the size of the crack.

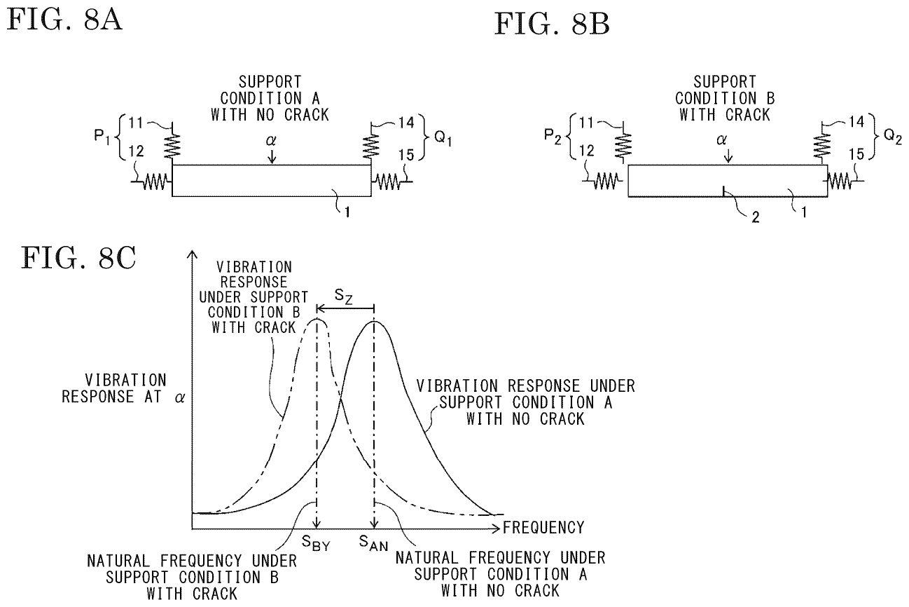

FIG. 8 shows an example in which the natural frequency changes due to the crack 2 and change of the rigidities of the support portions of the inspection target 1. In FIG. 8(a), the support condition A is applied, so that the rigidities 11, 12 of the support portions correspond to the springs P1 and the rigidities 14, 15 correspond to the springs Q1. In FIG. 8(b), the support condition B is applied, so that the rigidities 11, 12 of the support portions correspond to the springs P2 and the rigidities 14, 15 correspond to the springs Q2. The point a at which response is measured is the same as in FIG. 6 and FIG. 7. In the case where there is a crack, there is the crack 2 in the inspection target 1. The measured vibration responses are shown as a schematic graph in FIG. 8(c) in which the horizontal axis indicates a frequency and the vertical axis indicates response displacement. In FIG. 8(c), vibration response under the support condition A with no crack is indicated by a solid line, and vibration response under the support condition B with the crack 2 is indicated by a two-dot dashed line. The natural frequency calculating unit 61 calculates the natural frequency from vibration response in the mode in which change of the natural frequency due to presence/absence of the crack and due to the crack 2 is great. In FIG. 8(c), S_{AN} is the natural frequency under the support condition A with no crack 2, and S_{BY} is the natural frequency under the support condition B with the crack 2. The natural frequency change amount calculating unit 62 calculates a change amount S_{Z} from the natural frequency SAN to the natural frequency S_{BY}.

The change S_{Z} of the natural frequency is different from the change S_{V} of the natural frequency in FIG. 6 and the change S_{W} of the natural frequency in FIG. 7. Change of the support condition, presence/absence of a crack, and the size of a crack are estimated from change of the natural frequency, through the following procedure.

### Procedure Before Inspection

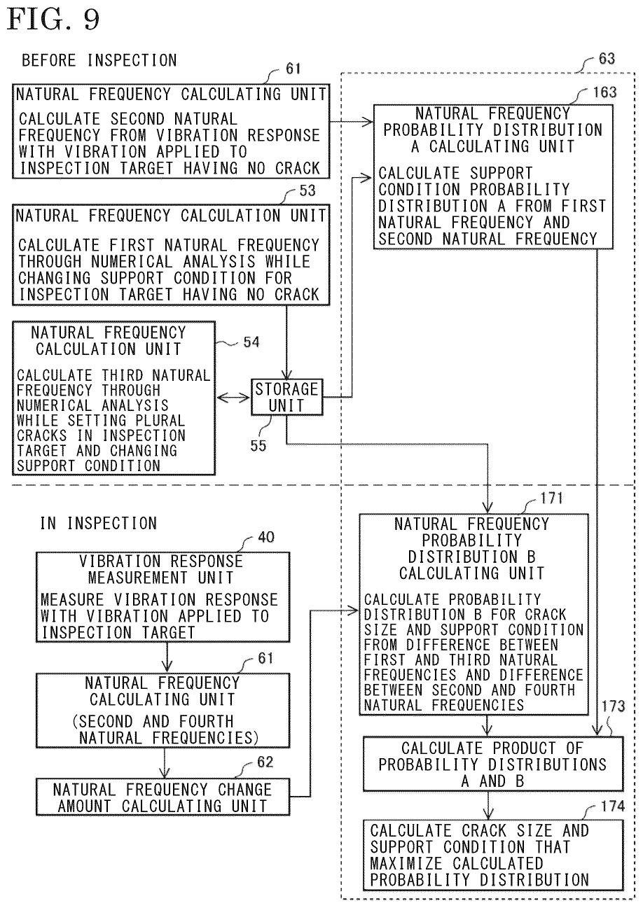

The support-portion-rigidity-and-damage-size estimation unit 63 in the estimation unit 60 shown in FIG. 1, will be described in detail. FIG. 9 shows a flowchart of an estimation method. Before actual inspection is performed with the inspection target 1 determined, the natural frequency calculation unit 53 calculates a natural frequency (referred to as a first natural frequency) through numerical analysis while changing the support condition for the inspection target 1 whose damage state such as a crack has already been known, e.g., there is no damage such as a crack (the size of damage is zero). The calculation result is stored in the storage unit 55. The natural frequency calculating unit 61 calculates a natural frequency (referred to as a second natural frequency) from vibration response measured when the vibration application unit 30 applies vibration to the inspection target whose damage state such as a crack has already been known. The first natural frequency and the second natural frequency are inputted to the natural frequency probability distribution A calculating unit 163, whereby the support condition is calculated as a probability distribution A.

Next, the natural frequency calculation unit 54 calculates a natural frequency (referred to as a third natural frequency) through numerical analysis while setting a plurality of shapes of damage in the inspection target (changing the size of damage which is not zero) and changing the support condition. The calculated third natural frequency is stored in the storage unit 55 (hereinafter, damage may be referred to as a crack).

### Procedure in Inspection

In inspection, the vibration response measurement unit 40 measures vibration response with vibration applied to the inspection target 1. The natural frequency calculating unit 61 calculates the natural frequency (referred to as fourth natural frequency) from the measured vibration response. The natural frequency change amount calculating unit 62 calculates a difference between the above second natural frequency measured before inspection and the fourth natural frequency. The calculation result and a difference between the first natural frequency and the third natural frequency stored in the storage unit 55 are inputted to the natural frequency probability distribution B calculating unit 171. The natural frequency probability distribution B calculating unit 171 calculates a probability distribution B for the support condition and the size of the crack 2 of the inspection target 1. The calculation unit 173 calculates a product of the probability distribution A and the probability distribution B. From the calculation result of the product, the calculation unit 174 calculates the size of the crack and the support condition of the support portions that maximize the probability distribution.

### Details of Flow of Data Before Inspection

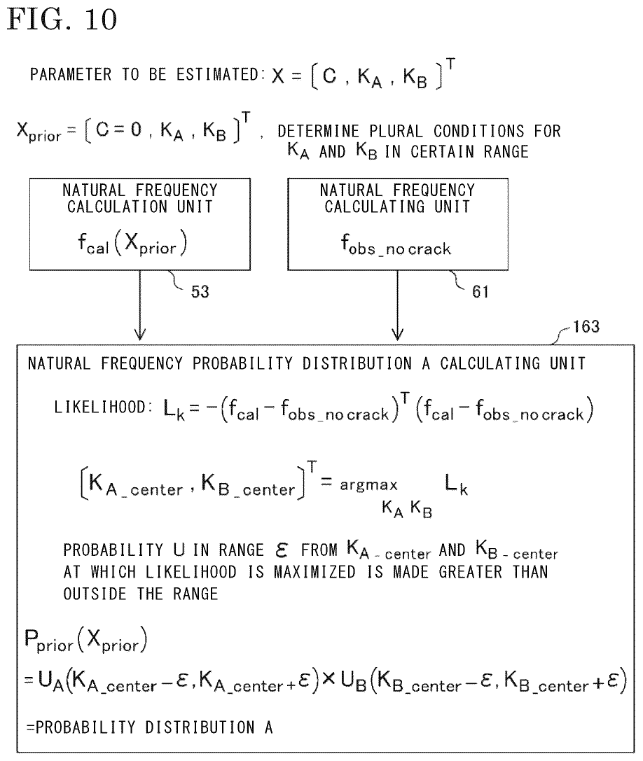

Specific flow of data among the natural frequency calculation unit 53, the natural frequency calculating unit 61, and the natural frequency probability distribution A calculating unit 163 before inspection will be described. FIG. 10 shows calculation flow in the natural frequency probability distribution A calculating unit 163. As shown in FIG. 10, change of the support condition and the size of the crack 2 to be estimated are defined as a vector of a parameter X to be estimated. Support conditions are denoted by K_{A} and K_{B}, and the size of the crack 2 is denoted by C. First, the size C of the crack 2 is set at 0, to define a parameter Xₚᵣᵢₒᵣ to be estimated. Here, ranges in which the support conditions K_{A} and K_{B} are changed are determined. The support conditions K_{A} and K_{B} for the shape model generated by the shape model generation unit 51 shown in FIG. 1 are changed by the natural frequency calculation unit 53, to calculate a first natural frequency f_{cal}(Xₚᵣᵢₒᵣ).

From the output of the vibration response measurement unit 40 when vibration is applied to the inspection target whose damage state such as a crack has already been known, e.g., there is no damage such as a crack (the size of damage is zero), the natural frequency calculating unit 61 calculates a second natural frequency f_{obs_nocrack}. The second natural frequency f_{obs_nocrack} and the first natural frequency f_{cal}(Xₚᵣᵢₒᵣ) calculated by the natural frequency calculation unit 53 are inputted to the natural frequency probability distribution A calculating unit 163. Then, natural frequencies K_{A_center} and K_{B_center} at which the likelihood is maximized as shown in the natural frequency probability distribution A calculating unit 163 are calculated. A certain range ε is determined such that estimation can be performed even if the calculated natural frequencies K_{A_center} and K_{B_center} are changed in the certain range. A probability of being in the range is made greater than a probability of being outside the range. Probabilities of being in the range are denoted by U_{A} and U_{B}. The probability distribution A is defined as Pₚᵣᵢₒᵣ(Xₚᵣᵢₒᵣ) and is calculated from the probabilities U_{A} and U_{B}.

### Details of Flow of Data in Inspection

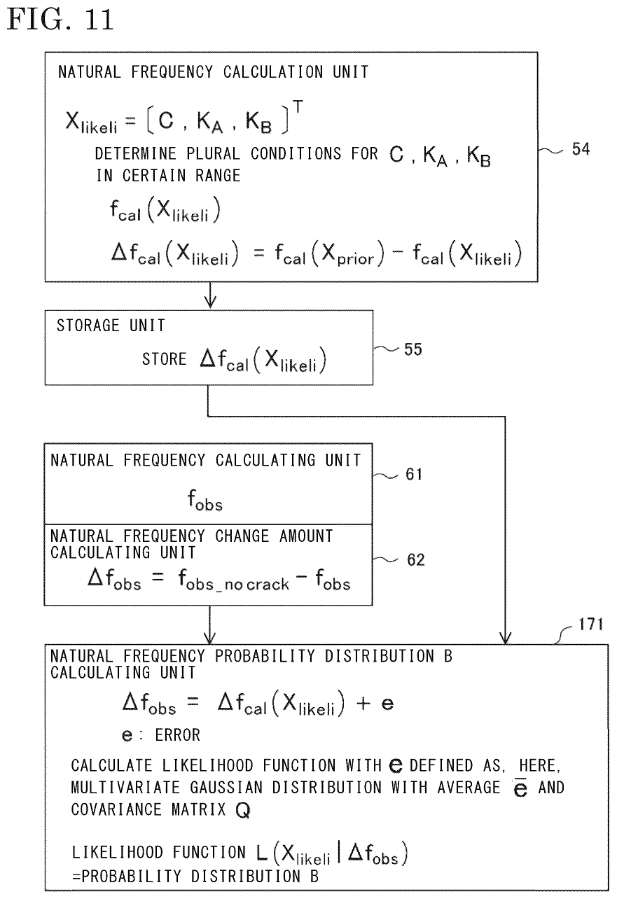

Flow of data in calculation of the natural-frequency probability distribution B calculated in inspection will be described. FIG. 11 shows a calculation flow for calculating the natural-frequency probability distribution B calculated from measured vibration response. As shown in FIG. 11, the natural frequency calculation unit 54 estimates the size C of a crack that is not zero, as well, with the parameter to be estimated denoted by Xₗᵢₖₑₗᵢ. Ranges in which the size C of the crack and the support conditions K_{A} and K_{B} are changed are determined. The third natural frequency f_{cal}(Xₗᵢₖₑₗᵢ) when the size C of the crack and the support conditions K_{A} and K_{B} are changed in the shape model generated by the shape model generation unit 51, is calculated in advance before inspection. A difference Δf_{cal}(Xₗᵢₖₑₗᵢ) between the calculated third natural frequency f_{cal}(Xₗᵢₖₑₗᵢ) and the first natural frequency f_{cal}(Xₚᵣᵢₒᵣ) calculated by the natural frequency calculation unit 53 is calculated. The storage unit 55 stores the difference Δf_{cal}(Xₗᵢₖₑₗᵢ).

The natural frequency calculating unit 61 calculates a fourth natural frequency f_{obs} which is calculated from the output of the vibration response measurement unit 40, and the natural frequency change amount calculating unit 62 calculates a change amount Δf_{obs} between the fourth natural frequency f_{obs} and the second natural frequency f_{obs_nocrack} calculated before inspection described in FIG. 10. In the natural frequency probability distribution B calculating unit 171, error e between the change amount Δf_{obs} and the difference Δf_{cal}(Xₗᵢₖₑₗᵢ) is regarded as having a certain probability distribution, and a likelihood function L(Xₗᵢₖₑₗᵢ|Δf_{obs}) is defined as the probability distribution B. In FIG. 11, a multivariate Gaussian distribution is used as an example of the probability distribution.

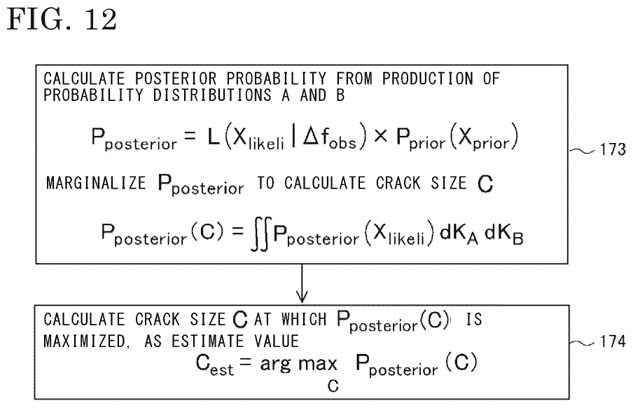

The calculation unit 173 which calculates a product of the probability distribution A and the probability distribution B, and the calculation unit 174 for the size of the crack and the support condition that maximize the probability distribution, will be described. FIG. 12 shows a calculation flow for calculating the size of the crack and the support condition that maximize a product of the probability distributions A and B. The calculation unit 173 for calculating a product of the probability distributions A and B calculates a product of the probability distribution B (L(Xₗᵢₖₑₗᵢ|Δf_{obs})) and the probability distribution A (Pₚᵣᵢₒᵣ(Xₚᵣᵢₒᵣ)). The product is defined as a posterior probability. In addition, in order to estimate the size C of the crack 2, the calculation unit 173 marginalizes the Pₚₒₛₜₑᵣᵢₒᵣ to calculate a Pₚₒₛₜₑᵣᵢₒᵣ(C). The size C that maximizes the calculated Pₚₒₛₜₑᵣᵢₒᵣ(C) is estimated as an estimate value Cₑₛₜ. This method is the same as a method in which a posterior probability is maximized by MAP which is a kind of Bayesian inference.

As described above, the inspection device 20 according to embodiment 1 includes: the vibration application unit 30 which applies vibration to the inspection target 1; the vibration response measurement unit 40 for the vibration-applied inspection target 1; the data recording unit 50 which records change of the natural frequency when the size of damage and the rigidity of a part where the inspection target 1 is supported are changed; and the estimation unit 60 in which the natural frequency calculating unit 61 calculates the natural frequency from the measured vibration response, the natural frequency change amount calculating unit 62 calculates change of the natural frequency from a value in a case where a damage state such as a crack has already been known, e.g., there is no damage such as a crack (the size of damage is zero), and the calculated change of the natural frequency and the change of the natural frequency recorded in the data recording unit 50 are combined to estimate the rigidity of the part where the inspection target 1 is supported and the size of damage that cannot be seen from a surface, simultaneously. Thus, since the rigidity of the part where the inspection target 1 is supported and the size of damage that cannot be seen from a surface are estimated simultaneously, accuracy for estimating the size of damage that cannot be seen from a surface is improved even if the rigidity of the supported part is changed.

### Embodiment 2

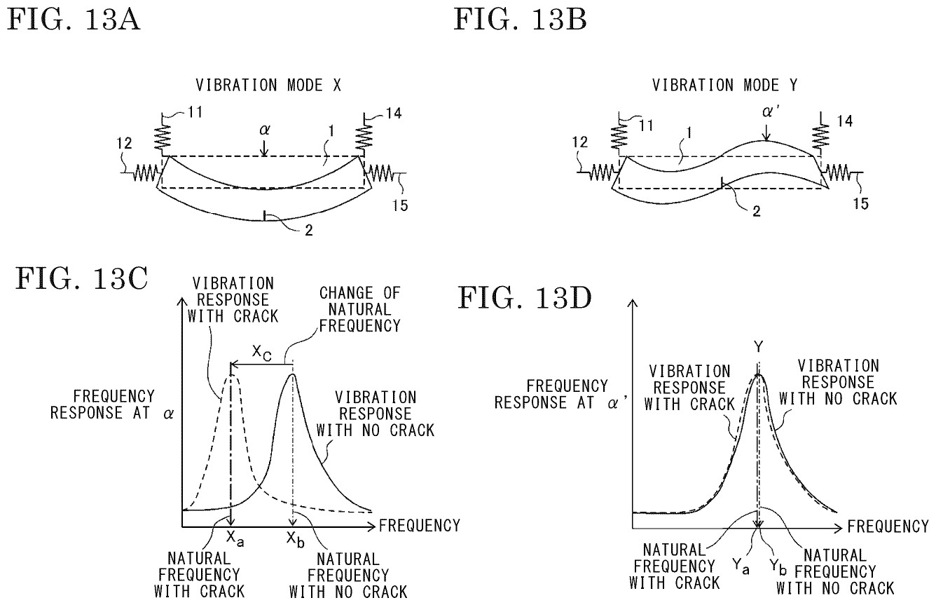

Only a difference from embodiment 1 will be described. The feature of the present embodiment is that, as a vibration mode in which the natural frequency is calculated by the inspection device 20 shown in embodiment 1, a vibration mode in which the natural frequency greatly changes due to damage that cannot been seen from a surface, in the inspection target 1, is selected. FIG. 13 shows vibration modes in which the natural frequency changes due to damage that cannot be seen from a surface, in the inspection target 1. Views in FIG. 13 are views of the inspection target 1 as seen in the direction A as described in FIG. 5, and change in the vibration mode due to the crack 2 will be described.

As shown in FIG. 13(a), in a vibration mode X in which the rigidity of the inspection target 1 is partially changed due to the crack 2 and the rigidity-changed part is greatly deformed, change of the natural frequency due to the crack 2 is great. As shown in FIG. 13(b), in a vibration mode Y in which the rigidity-changed part is not deformed, change of the natural frequency due to the crack 2 is small.

As shown in FIG. 13(c), in the vibration mode X in which the rigidity-changed part is greatly deformed, change X_{c} of the natural frequency between a natural frequency X_{b} with no crack calculated from vibration response with no crack and a natural frequency Xₐ with the crack 2 calculated from vibration response with the crack 2, is great to a certain extent. However, in the vibration mode Y in which the rigidity-changed part is not deformed, as shown in FIG. 13(d), the magnitude of change of the natural frequency between a natural frequency Y_{b} with no crack calculated from vibration response with no crack and a natural frequency Yₐ with the crack 2 calculated from vibration response with the crack 2, is very small. Therefore, using only a vibration mode in which change of the natural frequency due to a crack is great as represented by the vibration mode X, the natural frequency and the change amount of the natural frequency are calculated in the inspection device 20.

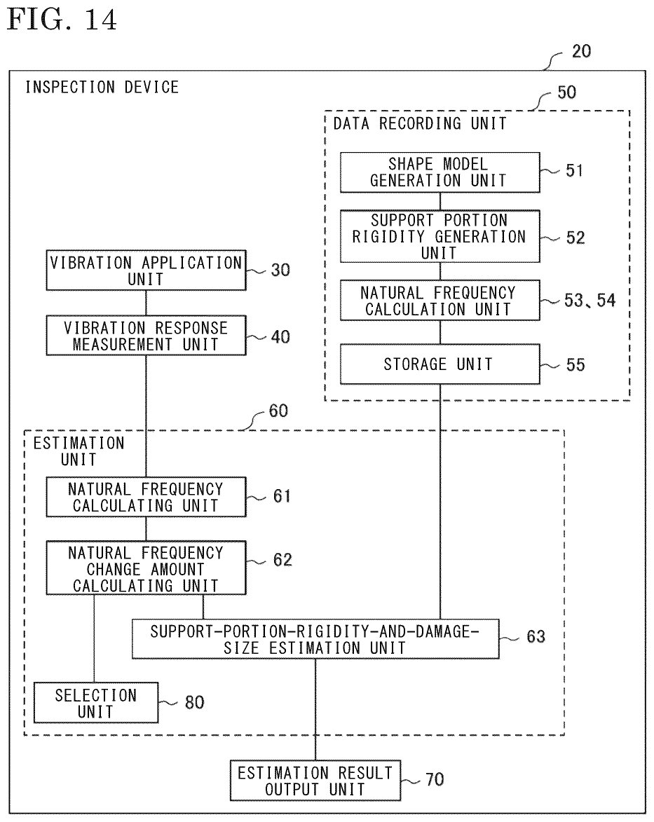

Accordingly, as shown in FIG. 14, the inspection device 20 includes a selection unit 80 which selects a vibration mode in which the natural frequency changes greatly due to damage that cannot be seen from a surface, in the inspection target 1. The selection unit 80 may perform selection on the basis of a result from the natural frequency change amount calculating unit 62. Using the vibration mode in which change of the natural frequency is great and which is selected by the selection unit 80, the estimation unit 60 performs processing thereon, whereby a time required for estimation can be shortened. Further, increase in estimation error due to usage of a mode in which change of the natural frequency due to damage that cannot be seen from a surface is small, is prevented.

### Embodiment 3

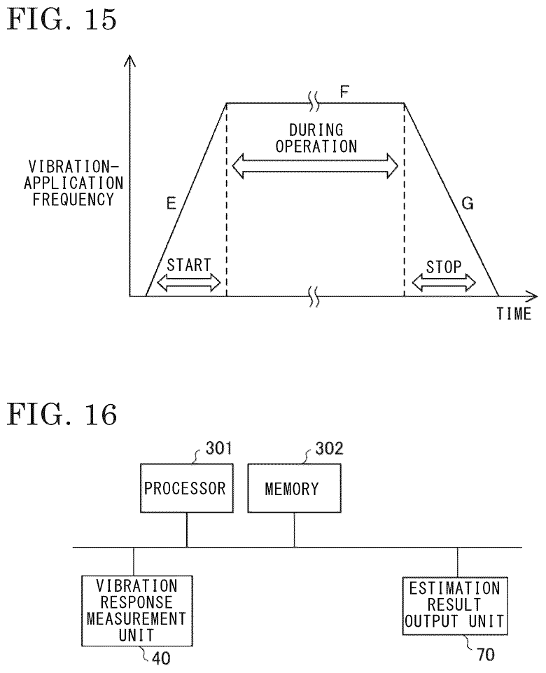

In the present embodiment, the inspection device 20 uses vibration response during operation or between operation and stop of the inspection target 1, instead of applying vibration by the vibration application unit 30. FIG. 15 shows change of a vibration-application frequency during operation or between start and stop in this case. In FIG. 15, the horizontal axis indicates time, and the vertical axis indicates the frequency of vibration-application force acting on the inspection target 1 in starting, stopping, or operation. Here, a case where the inspection target 1 is a rotary machine will be described, as an example. When the rotary machine is started from a stopped state, the rotation speed thereof increases until the rotary machine comes into an operation state. Along with increase in the rotation speed, the frequency of the vibration-application force acting on the rotary machine also increases (E in FIG. 15). During operation, there is no change or little change of the frequency (F in FIG. 15). At the time of stopping, the frequency decreases (G in FIG. 15). In this way, vibration is applied to the inspection target 1 through change of the vibration-application frequency, and vibration response at this time is measured.

FIG. 16 shows a hardware configuration diagram in the present embodiment. As described above, the vibration application unit 30 is not needed but control of the rotary machine is performed by the processor 301 on the basis of a program recorded in the memory 302 so that start, operation, and stop described in FIG. 15 is controlled, as shown in FIG. 15.

With the configuration as described above, vibration application to the inspection target 1 is performed using vibration in operation of the inspection target 1. Thus, the vibration application unit need not be provided and the inspection device can be downsized.

### Embodiment 4

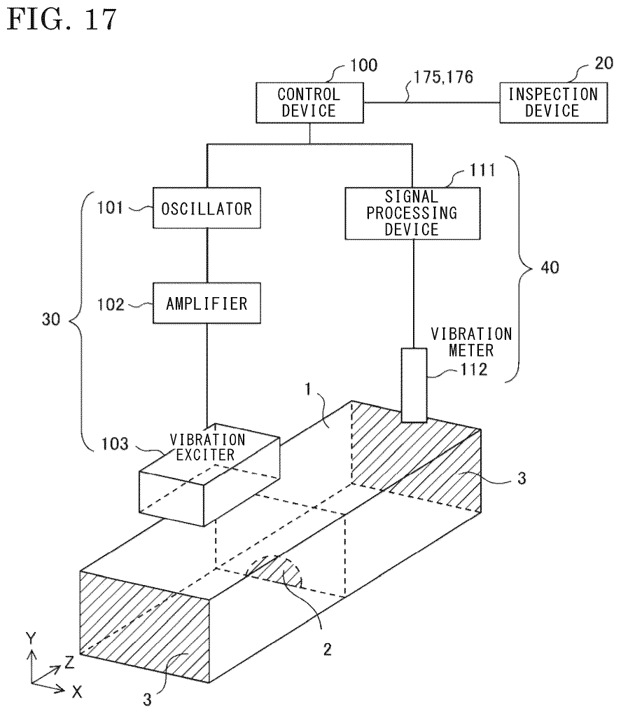

FIG. 17 shows an inspection target and an inspection device in the present embodiment. In embodiment 1, the inspection device 20 is included in the control device 100. However, some of the functions of the inspection device 20 may be separated from the control device, whereby size reduction of the control device 100 is achieved. Hereinafter, this configuration will be described in detail. The present embodiment is also applicable to embodiments 5, 6, 7 described later.

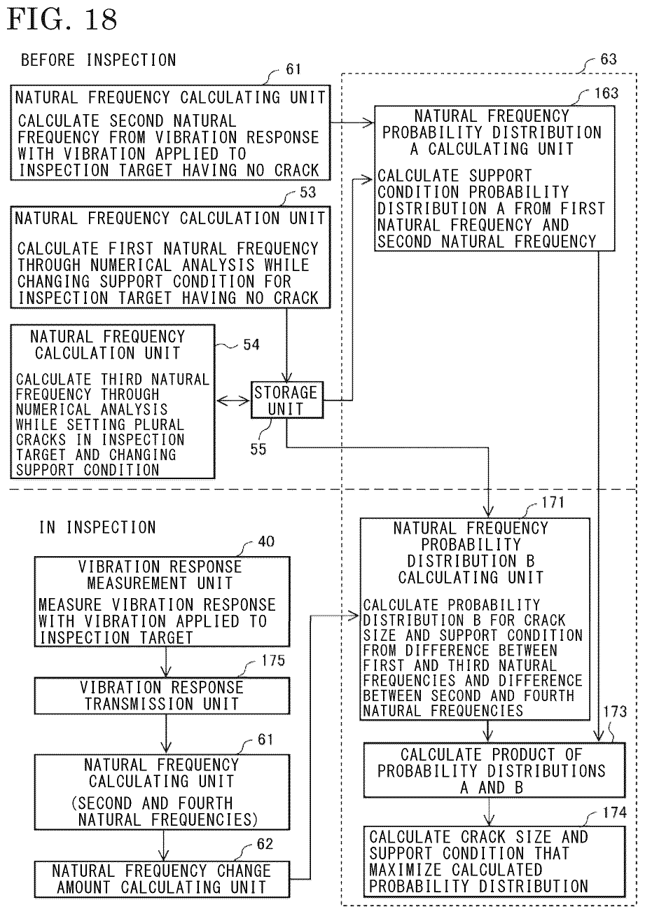

FIG. 18 is a flowchart of an estimation method in the present embodiment. Only changes from embodiment 1 will be described. The feature of the present embodiment is as follows. As shown in FIG. 17 and FIG. 18, in inspection, the vibration application unit 30 applies vibration to the inspection target 1 and vibration response is measured. A vibration response transmission unit 175 transmits the measured vibration response, and the natural frequency calculating unit 61 calculates the natural frequency.

As described above, vibration response measured by the vibration response measurement unit 40 is transmitted by the vibration response transmission unit 175. Thus, the estimation unit 60 of the inspection device 20 need not be placed near the inspection target 1, and the inspection device can be downsized.

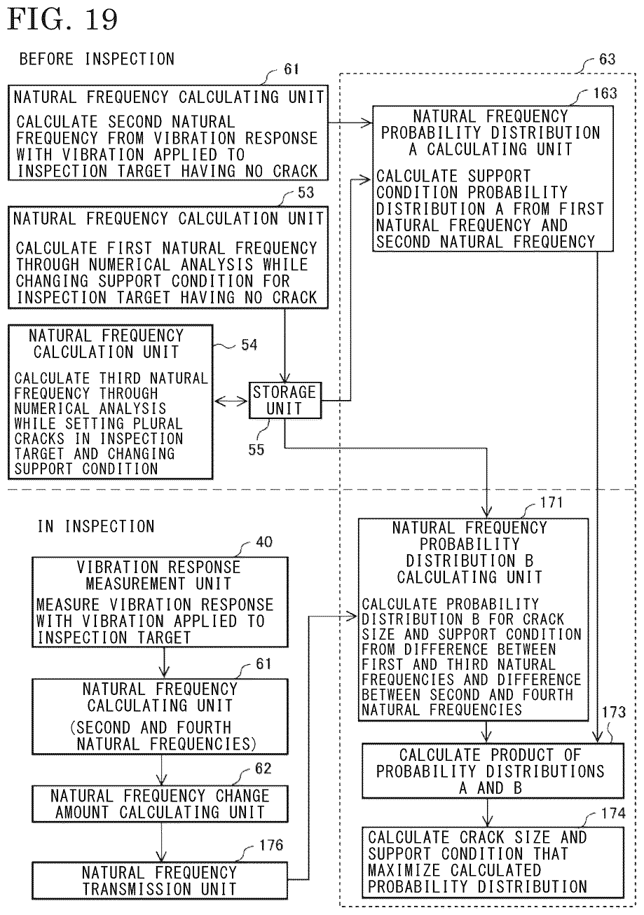

FIG. 19 is a flowchart of another estimation method in the present embodiment. Only changes from embodiment 1 will be described. The feature of the present embodiment is as follows. As shown in FIG. 17 and FIG. 19, in inspection, the vibration response measurement unit 40 measures vibration response of the inspection target 1. From the measured vibration response, the natural frequency calculating unit 61 calculates the natural frequency, and the natural frequency change amount calculating unit 62 calculates the change amount of the natural frequency. A natural frequency transmission unit 176 transmits the calculated change amount of the natural frequency to the natural frequency probability distribution B calculating unit 171, which then calculates the probability distribution B.

As described above, the change amount of the natural frequency is calculated from the measured vibration response, and then is transmitted by the natural frequency transmission unit 176, whereby the amount of transmitted data can be reduced, and since some of the functions of the inspection device 20 can be separately located via the natural frequency transmission unit 176, the inspection device 20 can be downsized.

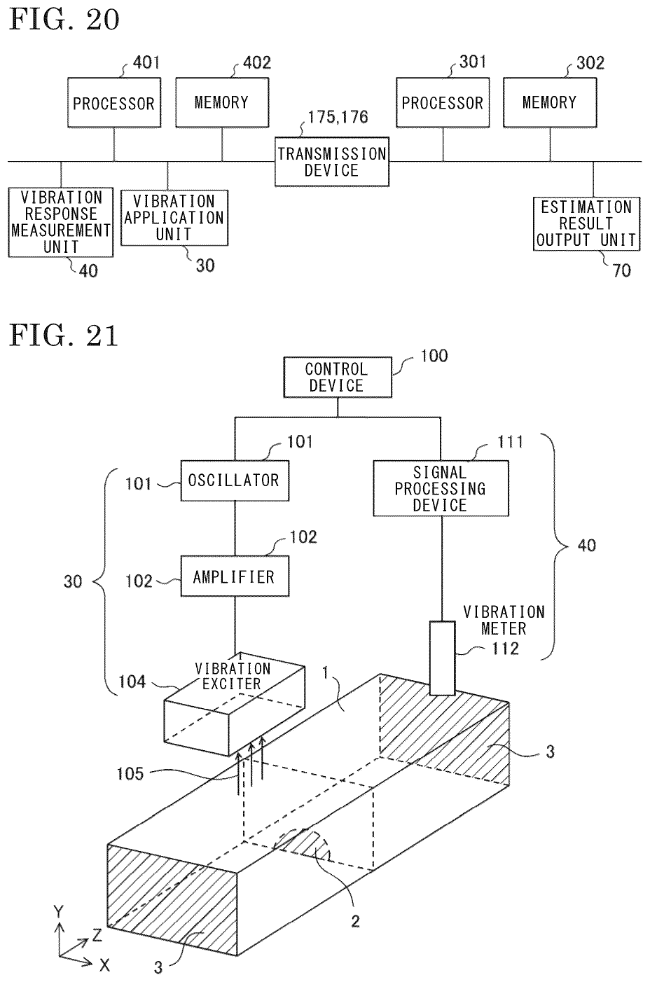

The vibration response transmission unit 175 and the natural frequency transmission unit 176 are implemented by a transmission device composed of a transmitter, a receiver, an optical fiber or a coaxial cable serving as a transmission/reception path, and the like, as shown in FIG. 20. Processing for generating data to be transmitted is implemented by a processor 401 such as a CPU or a system LSI which executes a program recorded in a memory 402. The memory 402 is, for example, a nonvolatile or volatile semiconductor memory such as a ROM, a RAM, a flash memory, an EPROM, or an EEPROM, or a magnetic disk, a flexible disk, an optical disc, a compact disc, a mini disc, a DVD, etc. A plurality of processing circuits may cooperate to execute the above functions. The above functions may be implemented by dedicated hardware. In a case of implementing the above functions by dedicated hardware, the dedicated hardware is, for example, a single circuit, a complex circuit, a programmed processor, an ASIC, an FPGA, or a combination thereof. The above functions may be implemented by a combination of dedicated hardware and software or a combination of dedicated hardware and firmware.

### Embodiment 5

FIG. 21 is a schematic diagram showing an inspection device according to embodiment 6 and an inspection target by the inspection device. The vibration application unit 30 shown in FIG. 21 includes the oscillator 101, the amplifier 102, and a vibration exciter 104, and is controlled by the control device 100. The vibration response measurement unit 40 includes the signal processing device 111 and the vibration meter 112, and is controlled by the control device 100, as with the vibration application unit 30.

For the inspection target 1, an oscillation signal is generated by the oscillator 101 on the basis of a signal inputted from the control device 100, and then is inputted to the amplifier 102. The oscillation signal amplified by the amplifier 102 is inputted to the vibration exciter 104, to apply vibration to the inspection target 1. The vibration exciter 104 applies vibration by induced electromagnetic force, and thus vibration application to the inspection target 1 can be performed in a contactless manner by the electromagnetic force.

As described above, the vibration application unit uses electromagnetic-induction vibration application to apply vibration, whereby vibration application can be performed in a contactless manner and the inspection time can be shortened.

### Embodiment 6

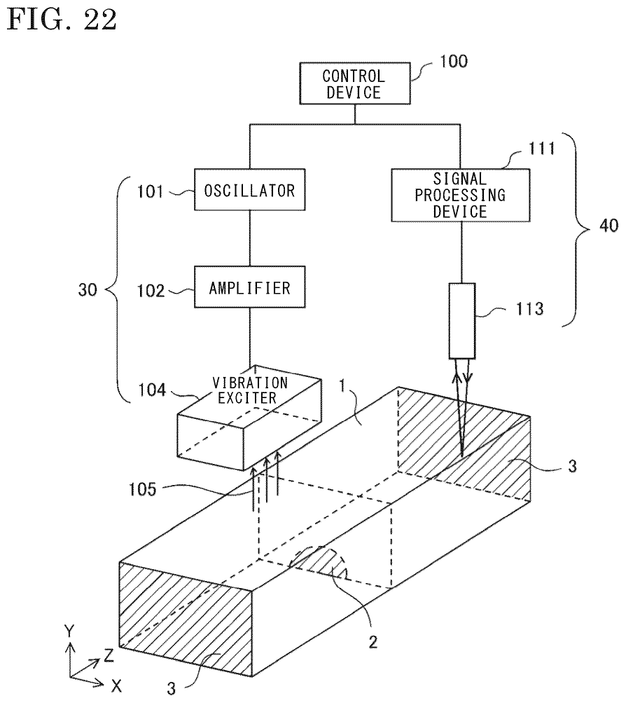

FIG. 22 is a schematic diagram showing an inspection device according to embodiment 7 and an inspection target by the inspection device. The vibration application unit 30 shown in FIG. 22 includes the oscillator 101, the amplifier 102, and the vibration exciter 104, and is controlled by the control device 100. The vibration response measurement unit 40 includes the signal processing device 111 and a vibration meter 113, and is controlled by the control device 100, as with the vibration application unit 30.

For the inspection target 1, an oscillation signal is generated by the oscillator 101 on the basis of a signal inputted from the control device 100, and then is inputted to the amplifier 102. The oscillation signal amplified by the amplifier 102 is inputted to the vibration exciter 104 which performs vibration application by induced electromagnetic force, to apply vibration to the inspection target 1. The vibration meter 113 can measure vibration response displacement in a contactless manner by laser Doppler.

As described above, the vibration application unit uses electromagnetic-induction vibration application and the vibration meter 113 of a laser Doppler type is used, whereby vibration response can be measured in a contactless manner and the inspection time can be shortened.

### Embodiment 7

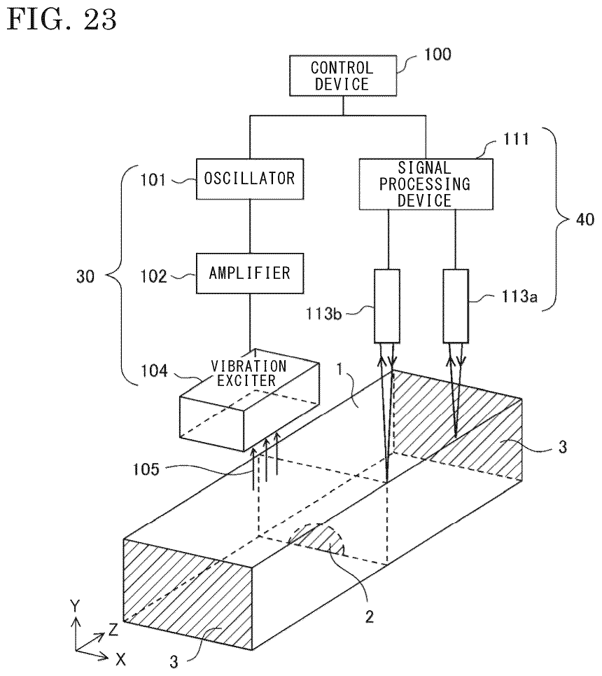

FIG. 23 is a schematic diagram showing an inspection device according to embodiment 8 and an inspection target by the inspection device. The vibration application unit 30 shown in FIG. 19 includes the oscillator 101, the amplifier 102, and the vibration exciter 104, and is controlled by the control device 100. The vibration response measurement unit 40 includes the signal processing device 111 and vibration meters 113a, 113b, and is controlled by the control device 100, as with the vibration application unit 30.

For the inspection target 1, an oscillation signal is generated by the oscillator 101 on the basis of a signal inputted from the control device 100, and then is inputted to the amplifier 102. The oscillation signal amplified by the amplifier 102 is inputted to the vibration exciter 104 which performs vibration application by induced electromagnetic force, to apply vibration to the inspection target 1. By using the vibration meters 113a, 113b of a laser Doppler type, vibration response displacement can be measured in a contactless manner at a plurality of locations at once.

As described above, by using a plurality of vibration meters 113a, 113b of a laser Doppler type, the measurement time for response displacement can be shortened.

Although the disclosure is described above in terms of various exemplary embodiments, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 inspection target
2 crack
3 support portion
20 inspection device
30 vibration application unit
40 vibration response measurement unit
50 data recording unit
51 shape model generation unit
52 support portion rigidity generation unit
53, 54 natural frequency calculation unit
55 storage unit
60 estimation unit
61 natural frequency calculating unit
62 natural frequency change amount calculating unit
63 support-portion-rigidity-and-damage-size estimation unit
70 estimation result output unit
100 control device
101 oscillator
102 amplifier
103, 104 vibration exciter
111 signal processing device
112, 113, 113a, 113b vibration meter
163 natural frequency probability distribution A calculating unit
171 natural frequency probability distribution B calculating unit
173, 174 calculation unit
175 vibration response transmission unit
176 natural frequency transmission unit

1. An inspection device comprising:
a data recording circuitry which records, in advance, change of a natural frequency caused when a rigidity of a part where an inspection target object is supported and a size of damage of the inspection target object are changed;
a measurement circuitry which measures vibration response of the inspection target object subjected to vibration application; and
an estimation circuitry which estimates the rigidity of the part where the inspection target object is supported and the size of damage of the inspection target object, simultaneously, on the basis of a first probability distribution with respect to change of a support condition for the inspection target object calculated from the natural frequency recorded in the data recording circuitry and a second natural frequency obtained by measuring the inspection target object whose damage has already been known, a fourth natural frequency of the inspection target object calculated from the vibration response measured by the measurement circuitry, and the change of the natural frequency recorded in the data recording circuitry.

2. The inspection device according to claim 1, wherein
the first probability distribution is calculated from a first natural frequency recorded in the data recording circuitry and calculated while changing the rigidity of the part where the inspection target object is supported, and the second natural frequency, and
the estimation circuitry calculates a second probability distribution with respect to changes of the damage and the rigidity, using change, from the first natural frequency, of a third natural frequency recorded in the data recording circuitry and obtained when the damage and the rigidity are changed, and change, from the second natural frequency, of the fourth natural frequency of the inspection target object in inspection, and
calculates, as the estimated size of damage, the size of damage at which a third probability distribution obtained by multiplying the first probability distribution and the second probability distribution is maximized.

3-16. (canceled)

17. The inspection device according to claim 2, wherein
the first natural frequency is the natural frequency calculated while changing the rigidity of the part where the inspection target object in which the size of damage is zero is supported, and
the third natural frequency is the natural frequency obtained when the damage whose size is not zero and the rigidity are changed.

18. The inspection device according to claim 2, wherein
in the estimation circuitry, the third probability distribution is maximized by using Bayesian inference.

19. The inspection device according to claim 2, wherein
a selection circuitry for selecting a vibration mode in which change from the second natural frequency to the fourth natural frequency is greater than a predetermined value, is provided, and inspection is performed using the vibration mode selected by the selection circuitry.

20. The inspection device according to claim 1, wherein
the inspection target object is subjected to vibration application by vibration in operation of the inspection target object.

21. The inspection device according to claim 1, wherein
the estimation circuitry is placed at a predetermined distance from the measurement circuitry, and
the inspection device further comprises a transmission circuitry which transmits vibration response measured by the measurement circuitry to the estimation circuitry.

22. An inspection device comprising:
a data recording circuitry which records, in advance, change of a natural frequency caused when a rigidity of a part where an inspection target object is supported and a size of damage of the inspection target object are changed;
a measurement circuitry which measures vibration response of the inspection target object subjected to vibration application; and
an estimation circuitry which estimates the rigidity of the part where the inspection target object is supported and the size of damage of the inspection target object, simultaneously, on the basis of change of the natural frequency between a natural frequency of the inspection target object calculated from the vibration response measured by the measurement circuitry and a natural frequency obtained by measuring the inspection target object whose damage state has already been known, and the change of the natural frequency recorded in the data recording circuitry, wherein
the estimation circuitry includes
a natural frequency calculation circuitry which calculates a first natural frequency while changing the rigidity of the part where the inspection target object in which the size of damage is zero is supported, the first natural frequency being recorded in the data recording circuitry, and calculates a third natural frequency obtained when the damage whose size is not zero and the rigidity are changed, the third natural frequency being recorded in the data recording circuitry,
a natural frequency calculating circuitry which calculates a second natural frequency which is measured before inspection and obtained by applying vibration to the inspection target object whose damage state has already been known, and calculates a fourth natural frequency from vibration response measured on the inspection target object in inspection,
a natural frequency change amount calculating circuitry which calculates change of the fourth natural frequency from the second natural frequency,
a first probability distribution calculating circuitry which calculates a probability distribution with respect to change of a support condition for the inspection target object, on the basis of the first natural frequency and the second natural frequency,
a second probability distribution calculating circuitry which calculates a probability distribution with respect to changes of the damage and the support condition, on the basis of an output from the natural frequency change amount calculating circuitry and a difference between the first natural frequency and the third natural frequency, and
a multiplication circuitry which multiplies an output from the first probability distribution calculating circuitry and an output from the second probability distribution calculating circuitry, and
the estimation circuitry calculates, as the estimated size of damage, the size of damage at which an output of the multiplication circuitry is maximized.

23. The inspection device according to claim 22, wherein
the natural frequency calculating circuitry and the natural frequency change amount calculating circuitry of the estimation circuitry are placed at a predetermined distance from the estimation circuitry, together with the measurement circuitry, and
the inspection device further comprises a transmission circuitry to perform transmission of a signal to/from the estimation circuitry.

24. The inspection device according to claim 22, wherein
vibration application to the inspection target object is performed by a vibration exciter using electromagnetic induction.

25. The inspection device according to claim 22, wherein
the measurement circuitry is provided with a laser Doppler vibration meter.

26. The inspection device according to claim 25, wherein
a plurality of the laser Doppler vibration meters are provided and displacement of the inspection target object is measured at a plurality of locations at once.

27. An inspection method comprising:
At least one processor and at least one memory including computer program code to execute following steps,
a first step of recording, in advance, change of a natural frequency caused when a rigidity of a part where an inspection target object is supported and a size of damage of the inspection target object are changed;
a second step of measuring vibration response of the inspection target object subjected to vibration application; and
a third step of estimating the rigidity of the part where the inspection target object is supported and the size of damage of the inspection target object, simultaneously, on the basis of a first probability distribution with respect to change of a support condition for the inspection target object calculated from the recorded natural frequency and a second natural frequency obtained by measuring the inspection target object whose damage has already been known, a fourth natural frequency of the inspection target object calculated from the vibration response measured in the second step, and the change of the natural frequency recorded in the first step.

28. The inspection method according to claim 27, wherein
the first probability distribution is calculated from a first natural frequency recorded and calculated while changing the rigidity of the part where the inspection target object is supported, and the second natural frequency, and
in the third step,
a second probability distribution with respect to changes of the damage and the rigidity is calculated using change, from the first natural frequency, of a third natural frequency recorded in the first step and obtained when the damage and the rigidity are changed, and change, from the second natural frequency, of-a the fourth natural frequency of the inspection target object in inspection, and
the size of damage at which a third probability distribution obtained by multiplying the first probability distribution and the second probability distribution is maximized, is calculated as the estimated size of damage.

29. The inspection method according to claim 28, wherein
the third probability distribution is maximized by using Bayesian inference.

30. The inspection method according to claim 28, wherein
a vibration mode in which change from the second natural frequency to the fourth natural frequency is greater than a predetermined value, is selected, and inspection is performed using the selected vibration mode.

31. The inspection method according to claim 27, wherein
the inspection target object is subjected to vibration application by vibration in operation of the inspection target object.
